(19) United States
(12) Patent Application Publication
(10) Pub. No.: US 2011/0033256 A1
(43) Pub. Date: Feb. 10, 2011

(54) Annular Sawing Structure

(76) Inventor: Johnson He, Hangzhou City (CN)

Correspondence Address: Dr. BANGER SHIA;Patent Office of Bang Shia, 102 Lindencrest Ct, Sugar Land, TX, 77479-5201, US

(21) Appl. No.: 12/537,248

(22) Filed: Aug. 6, 2009

(51) Int. Cl. B23B 51/04

(52) U.S. Cl. 408/201; 408/204; 408/206

(57) ABSTRACT

An annular sawing structure comprises: a sawing body including a saw member, a connecting member, and a positioning drill; the saw member including a sawtoothed blade disposed on a front end thereof; the connecting member including a groove being concentric with the saw member and secured on a front end thereof; the positioning drill fitted to the groove of the connecting member and including a cutting insertion fixed on a front end thereof and extending out of a sawtoothed blade of the saw member, the cutting insertion including a reduced end extending rearward therefrom and received in the receiving chamber of the saw member, and an outer diameter of the cutting insertion being lager than that of the reduced end, and the positioning drill further including an engaging end extending out of the connecting member to couple with an engaging head of a tool.

### BACKGROUND OF THE INVENTION

1. Field of the Invention

The present invention relates to an annular sawing structure that can remove a cut material easily.

2. Description of the Prior

Referring to FIGS. 1 and 2, a conventional annular sawing structure comprises a sawing body 10 including a saw member 11, a connecting member 12, and a positioning drill 13, the sawing body 11 including a toothed blade 111 disposed on a front end thereof, and the connecting member 12 mounted on a rear end thereof to fit the positioning drill 13, the positioning drill 13 including a head end 131 extending out of the front end of the sawing body 11. As cutting a circular hole on a plate member 20, a driving tool drives the sawing body 10 to rotate and then the head end 131 of the positioning drill 13 is fixed to the plate member 20 to cut the circular hole by using the toothed blade 111 of the saw member 11. Thereafter, a cut material 21 is received in the saw member 11, however, because an outer diameter of the head end 131 of the positioning drill 13 is equal to that of a shaft 132, the cut material 21 is retained on the shaft 132 of the positioning drill 13 without being removed. Therefore, the sawing body 10 has to be removed from the driving tool and then a rear end of the positioning drill 13 is impacted to disengage from the sawing member 11, enabling to remove the cut material from the positioning drill 13. Finally, the positioning drill 13 is installed to the sawing member 11 to couple with the driving tool to have a further cutting process, causing a cutting inconvenience.

The present invention has arisen to mitigate and/or obviate the afore-described disadvantages.

### SUMMARY OF THE INVENTION

The primary object of the present invention is to provide an annular sawing structure that comprises a sawing body including a saw member, a connecting member, and a positioning drill; wherein the saw member including a sawtoothed blade disposed on a front end thereof; the connecting member including a groove being concentric with the saw member and secured on a front end thereof; the positioning drill fitted to the groove of the connecting member and including a cutting insertion fixed on a front end thereof and extending out of a sawtoothed blade of the saw member, the cutting insertion including a reduced end extending rearward therefrom and received in the receiving chamber of the saw member, and an outer diameter of the cutting insertion being lager than that of the reduced end, and the positioning drill further including an engaging end extending out of the connecting member to couple with an engaging head of a tool, thereby removing a cut material easily.

Another object of the present invention is to provide an annular sawing structure that comprises a sawing body including a saw member, a connecting member, and a positioning drill; the saw member including a sawtoothed blade disposed on a front end thereof; the connecting member mounted on a rear end thereof and including a groove being concentric with the saw member and secured on a front end thereof to fit a positioning drill, and including an engaging end fixed on a rear end thereof to couple with a driving tool; the positioning drill fitted to the groove of the connecting member and including a cutting insertion fixed on a front end thereof and extending out of a sawtoothed blade of the saw member, the cutting insertion including a reduced end extending rearward therefrom and received in the receiving chamber of the saw member, and an outer diameter of the cutting insertion being lager than that of the reduced end, thereby removing a cut material easily.

### BRIEF DESCRIPTION OF THE DRAWINGS

FIG. 1 is a cross sectional view showing the operation of a conventional annular sawing structure;

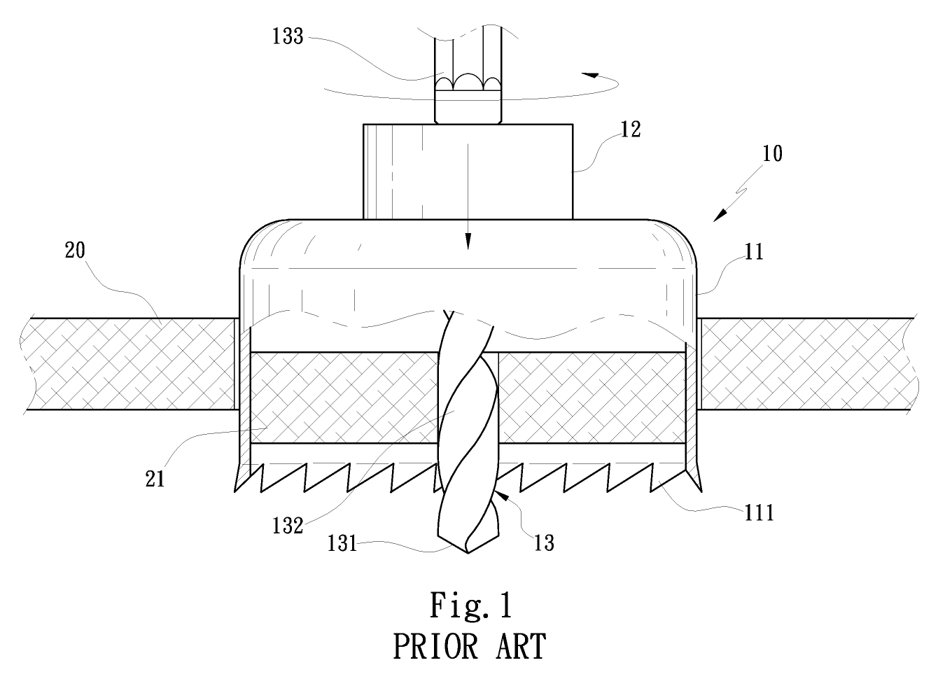

FIG. 2 is another cross sectional view showing the operation of the conventional annular sawing structure;

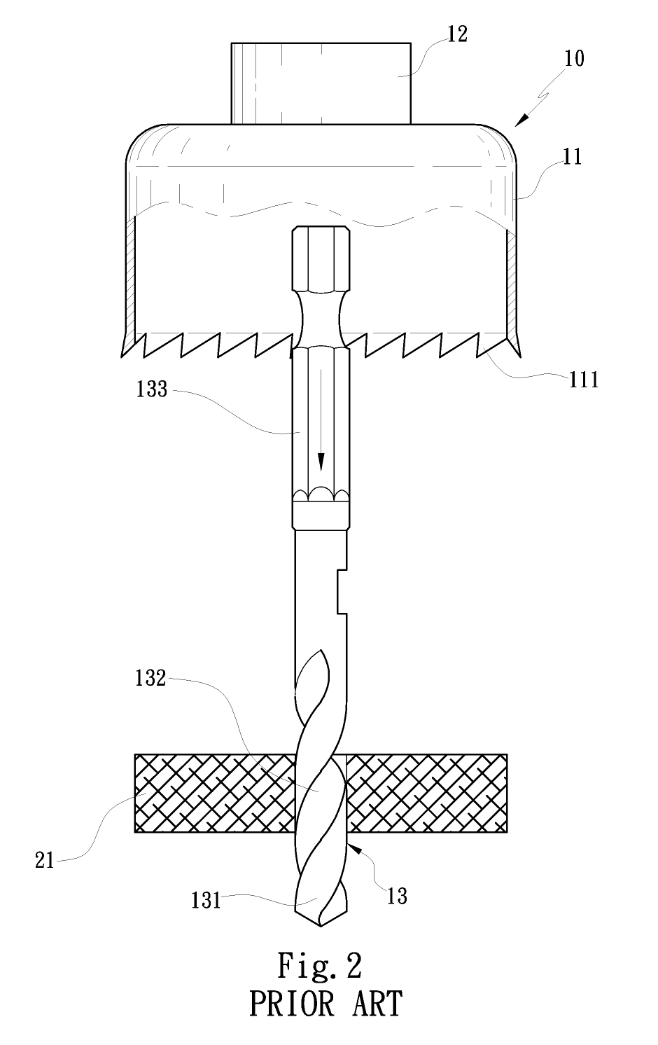

FIG. 3 is a perspective view showing the exploded components of an annular sawing structure in accordance with a preferred embodiment of the present invention;

FIG. 4 is a cross sectional view showing the assembly of the annular sawing structure in accordance with the preferred embodiment of the present invention;

FIG. 5 is a cross sectional view showing the operation of the annular sawing structure in accordance with the preferred embodiment of the present invention;

FIG. 6 is another cross sectional view showing the operation of the annular sawing structure in accordance with the preferred embodiment of the present invention;

FIG. 7 is another cross sectional view showing the operation of the annular sawing structure in accordance with the preferred embodiment of the present invention;

FIG. 8 is a perspective view showing different types of positioning drills;

FIG. 9 is a plan side view showing the positioning drills including engaging ends with different cross-sectional shapes respectively;

FIG. 10 is a perspective view showing the exploded components of an annular sawing structure in accordance with another preferred embodiment of the present invention;

FIG. 11 is a cross sectional view showing the assembly of the annular sawing structure in accordance with another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

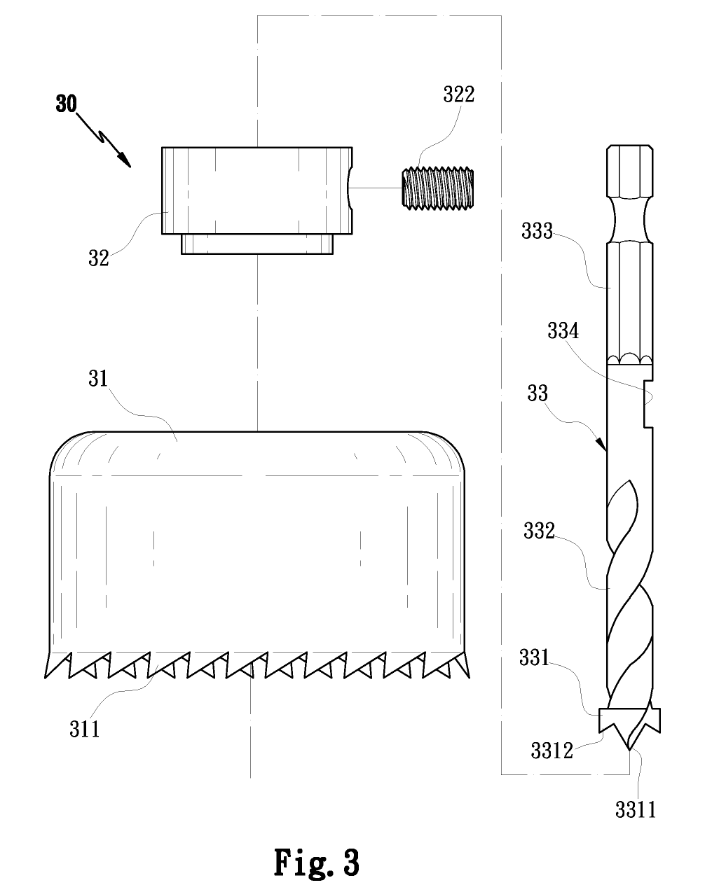

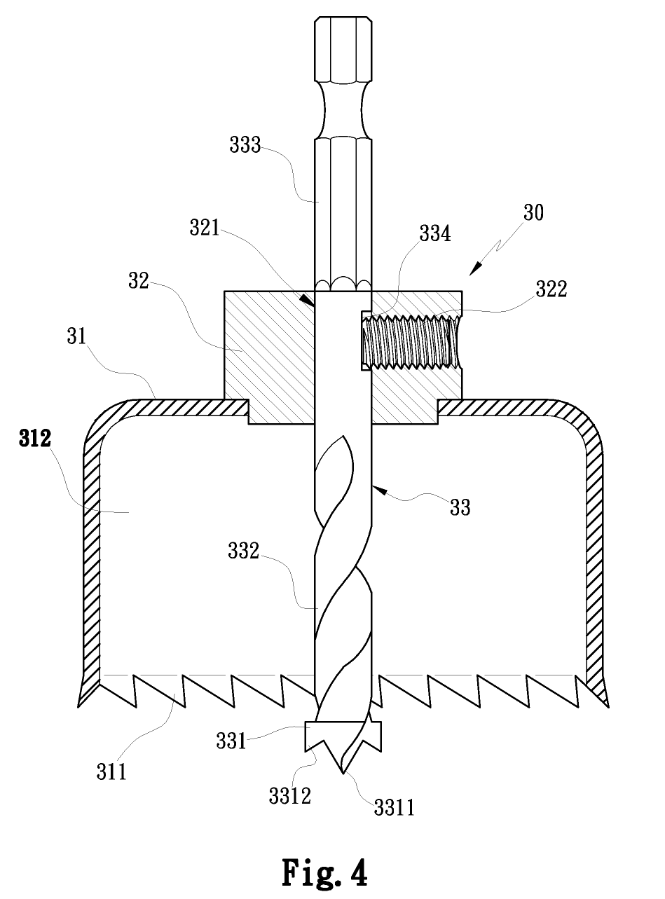

Referring to FIGS. 3 and 4, an annular sawing structure according to a preferment embodiment of the present invention comprises:

a sawing body 30 including a saw member 31, a connecting member 32, and a positioning drill 33;

the saw member 31 including a sawtoothed blade 311 disposed on a front end thereof to cut a circular hole, a receiving chamber 312 fixed therein to receive a cut material, and the connecting member 32 mounted on a rear end thereof and including a groove 321 being concentric with the saw member 31 and secured on a front end thereof to fit the positioning drill 33, and the positioning drill 33 including a cutting insertion 331 fixed on a front end thereof and extending out of the sawtoothed blade 311 of the saw member 31, the cutting insertion 331 including a tip 3311 formed on a front end thereof and a knife 3312 arranged on two sides of the tip 3311, and including a reduced end 332 extending rearward therefrom and received in the receiving chamber 312 of the saw member 31, and an outer diameter of the cutting insertion 331 being lager than that of the reduced end 332, wherein the cutting insertion 331 and the reduced end 332 are formed in a step shape, and the positioning drill 33 includes an engaging end 333 extending out of the connecting member 32 to couple with an engaging head of a tool, and between the positioning drill 33 and the connecting member 32 is defined a fixing structure. The fixing structure includes a screwed bore communicating with the groove 321 and formed on an outer periphery of the connecting member 32 to screw with a bolt 322, and includes a recess 334 disposed on the positioning drill 33 where is in response to the screwed bore of the connecting member 32, such that the bolt 322 is retained in the recess 334 of the positioning drill 33 to position the positioning drill 33.

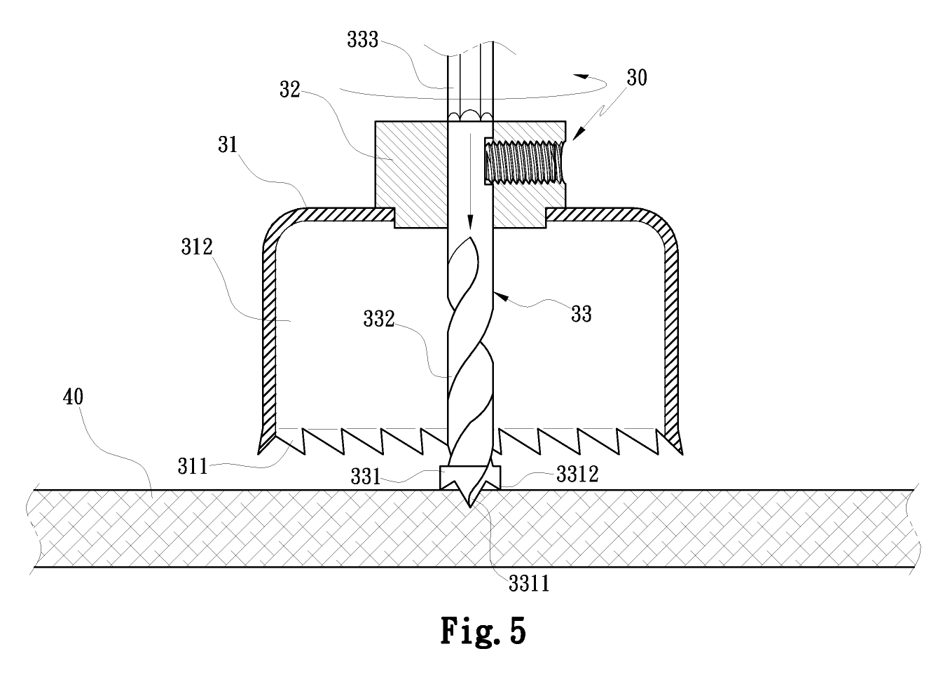

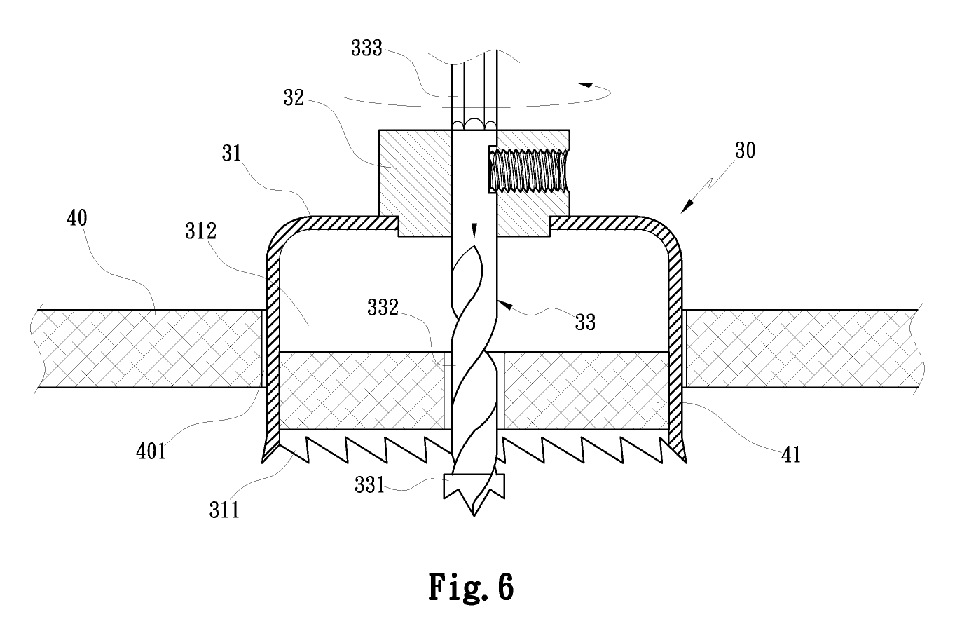

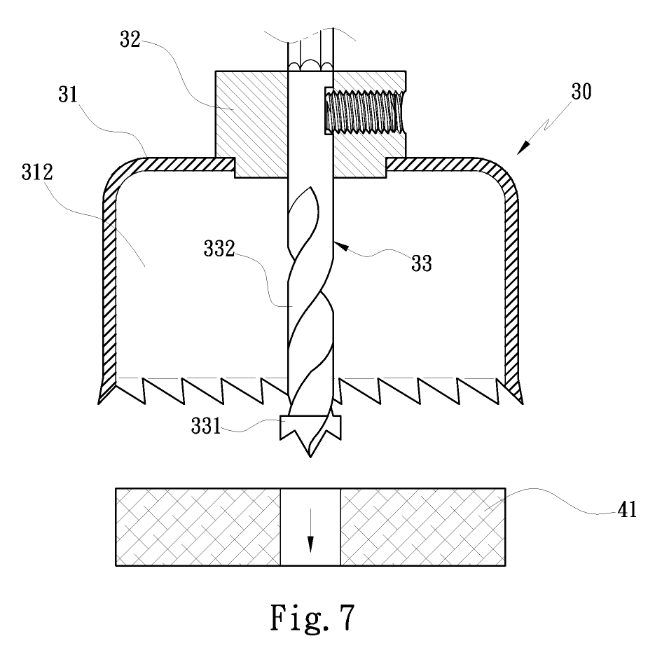

Referring to FIG. 5, the sawing body 30 is used to cut the circular hole on a plate member 40, wherein a driving tool is engaged with the engaging end 333 of the positioning drill 33 to actuate the sawing body 30 to rotate. The tip 3311 of the cutting insertion 331 of the positioning drill 33 is inserted to the plate member 40, and then the knife 3312 of the cutting insertion 331 is inserted to the plate member 40 to rotatably cut the plate member 40 by using the sawtoothed blade 311 of the saw member 31. As shown in FIG. 6, after a circular cut hole 401 is cut from the plate member 40, a cut material 41 is received in the receiving chamber 312 of the saw member 31. As illustrated in FIG. 7, the sawing body 30 is removed from the plate member 40 to finish the cutting process. Thereafter, the cut material 41 is removed from the receiving chamber 312 of the saw member 31, because the outer diameter of the cutting insertion 331 of the positioning drill 33 is larger than the that of the reduced end 332, the cut material is not retained in the reduced end 332 of the positioning drill 33, removing the cut material 41 easily.

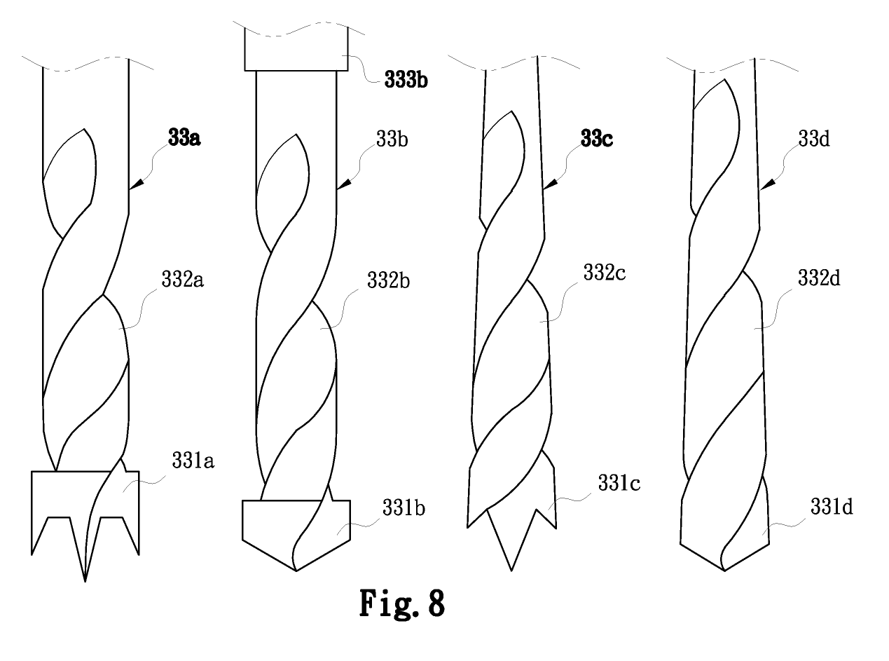

With reference to FIG. 8, the sawing body cam match with different type of positioning drills 33a, 33b, wherein an outer diameter of the cutting insertion 331a of the positioning drill 33a is more than that of a reduced end 332a, and outer diameters of a cutting insertion 331a and an engaging end 333b of the positioning drill 33a are more than that of the reduced end 332b, hence as one of the positioning drills 33a, 33b is selectively applied, the cut material is not retained in the reduced ends 332a, 332b of the positioning drills 33a, so as to be removed easily. Furthermore, as one of positioning drills 33c, 33d are selectively used, outer diameters of the positioning drills 33c, 33d are reduced from cutting insertions 331c and 331d to reduced ends 332c, 332d, e.g., outer diameters of the cutting insertions 331c, 331d are more than those of the reduced ends 332c, 332d to prevent a cut material from being retained in the reduced ends 332c, 332d of the positioning drills 33c, 33d, removing the cut material easily.

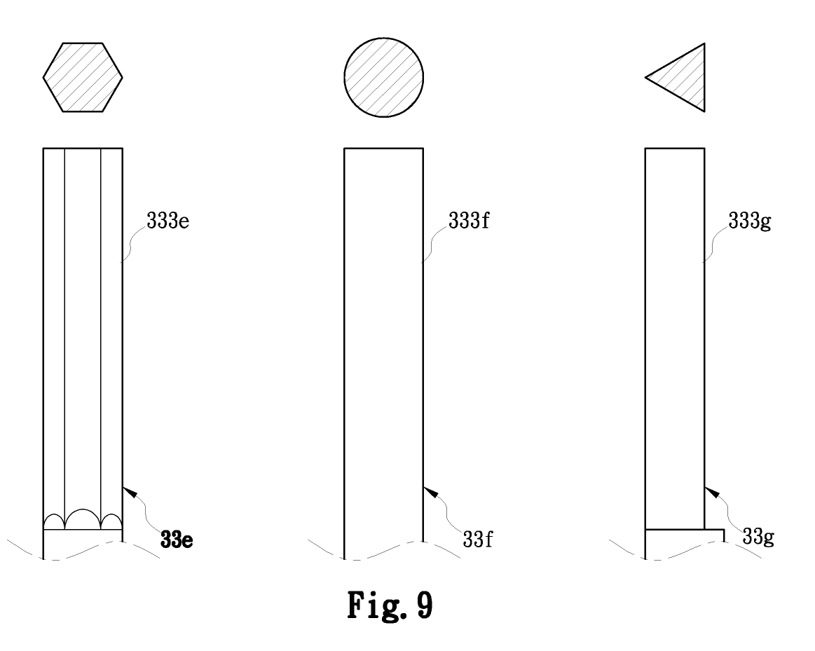

As shown in FIG. 9, the sawing body of the present invention can match with different types of positioning drills 33e, 33f, and 33g on the basis of engaging heads of driving tools, wherein the positioning drills 33e, 33f, and 33g include engaging ends 333e, 333f, 333g with different cross-sectional shapes respectively to cooperate with a suitable engaging head.

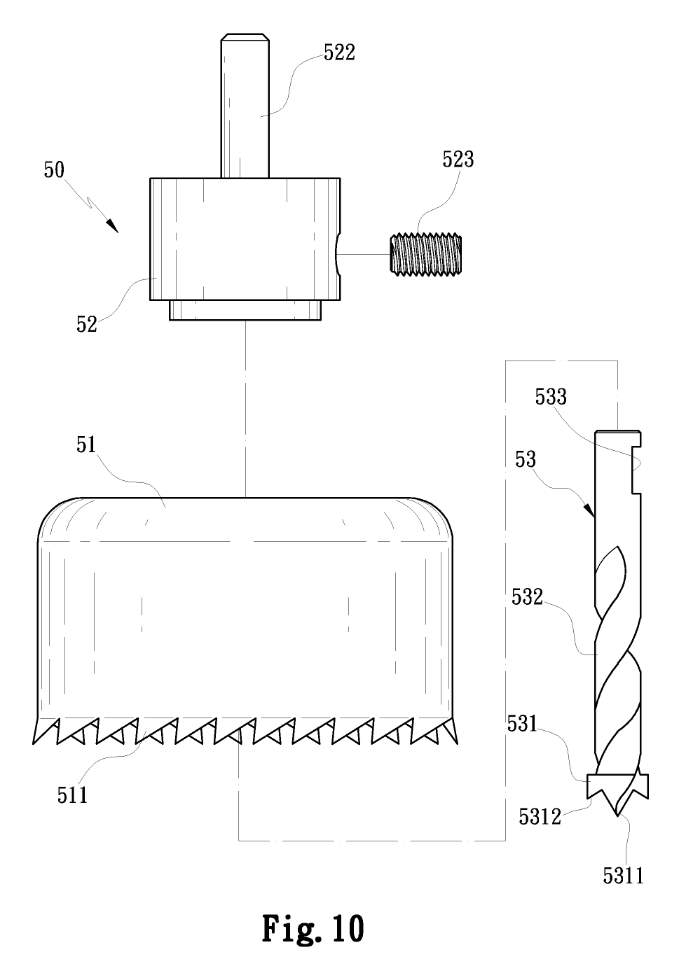

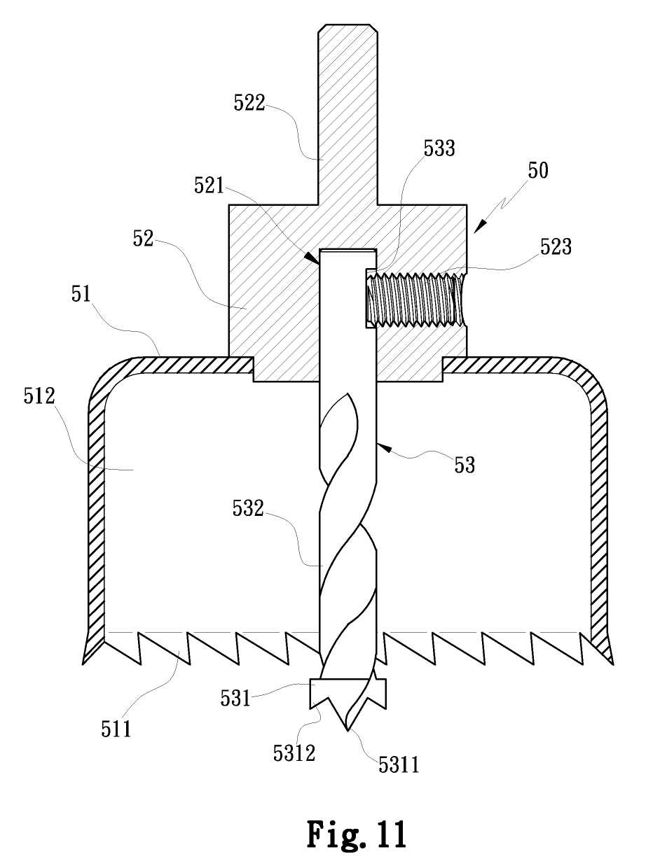

As illustrated in FIGS. 10 and 11, an annular sawing structure according to a preferment embodiment of the present invention comprises:

a sawing body 50 including a saw member 51, a connecting member 52, and a positioning drill 53;

the saw member 51 including a sawtoothed blade 511 disposed on a front end thereof to cut a circular hole, a receiving chamber 512 fixed therein to receive a cut material, and the connecting member 52 mounted on a rear end thereof and including a groove 521 being concentric with the saw member 51 and secured on a front end thereof to fit the positioning drill 53, and including an engaging end 522 fixed on a rear end thereof to couple with a driving tool, and the positioning drill 53 including a cutting insertion 531 fixed on a front end thereof and extending out of the sawtoothed blade 511 of the saw member 51, the cutting insertion 531 including a tip 5311 formed on a front end thereof and a knife 3312 arranged on two sides of the tip 5311, the cutting insertion 531 including a reduced end 532 received in the receiving chamber 512 of the saw member 51, and an outer diameter of the cutting insertion 531 being lager than that of the reduced end 532, wherein the cutting insertion 531 and the reduced end 532 are formed in a step shape and a reduced cone shape respectively, and between the positioning drill 53 and the connecting member 52 is defined a fixing structure. The fixing structure includes a screwed bore communicating with the groove 521 and formed on an outer periphery of the connecting member 52 to screw with a bolt 523, and includes a recess 533 disposed on a rear end of the positioning drill 53 where is in response to the screwed bore of the connecting member 52, such that the bolt 523 is retained in the recess 533 of the positioning drill 53 to position the positioning drill 53, such that after a circular hole is cut by using the sawing body 50, because the outer diameter of the cutting insertion 531 of the positioning drill 53 is larger than that of the reduced end 532, the cut material is not retained in the reduced end 532 of the positioning drill 53 to be removed easily.

While we have shown and described various embodiments in accordance with the present invention, it is clear to those skilled in the art that further embodiments may be made without departing from the scope of the present invention.

What is claimed is:

1. An annular sawing structure comprising:
a sawing body including a saw member, a connecting member, and a positioning drill;
the saw member including a sawtoothed blade disposed on a front end thereof;
the connecting member including a groove being concentric with the saw member and secured on a front end thereof;
the positioning drill fitted to the groove of the connecting member and including a cutting insertion fixed on a front end thereof and extending out of a sawtoothed blade of the saw member, the cutting insertion including a reduced end extending rearward therefrom and received in the receiving chamber of the saw member, and an outer diameter of the cutting insertion being lager than that of the reduced end, and the positioning drill further including an engaging end extending out of the connecting member to couple with an engaging head of a tool.

2. The annular sawing structure as claimed in claim 1, wherein the saw member includes a receiving chamber fixed therein.

3. The annular sawing structure as claimed in claim 1, wherein the cutting insertion includes a tip formed on a front end thereof and a knife arranged on two sides of the tip.

4. The annular sawing structure as claimed in claim 1, wherein the cutting insertion and the reduced end are formed in a step shape.

5. The annular sawing structure as claimed in claim 1, wherein the cutting insertion and the reduced end are formed in a step shape and a reduced cone shape respectively.

6. The annular sawing structure as claimed in claim 1, wherein between the positioning drill and the connecting member is defined a fixing structure to position the positioning drill.

7. The annular sawing structure as claimed in claim 6, wherein the fixing structure includes a screwed bore communicating with the groove and formed on an outer periphery of the connecting member to screw with a bolt, and includes a recess disposed on the positioning drill where is in response to the screwed bore of the connecting member.

8. An annular sawing structure comprising:
a sawing body including a saw member, a connecting member, and a positioning drill;
the saw member including a sawtoothed blade disposed on a front end thereof;
the connecting member mounted on a rear end thereof and including a groove being concentric with the saw member and secured on a front end thereof to fit a positioning drill, and including an engaging end fixed on a rear end thereof to couple with a driving tool;
the positioning drill fitted to the groove of the connecting member and including a cutting insertion fixed on a front end thereof and extending out of a sawtoothed blade of the saw member, the cutting insertion including a reduced end extending rearward therefrom and received in the receiving chamber of the saw member, and an outer diameter of the cutting insertion being lager than that of the reduced end.

9. The annular sawing structure as claimed in claim 8, wherein the saw member includes a receiving chamber fixed therein.

10. The annular sawing structure as claimed in claim 8, wherein the cutting insertion includes a tip formed on a front end thereof and a knife arranged on two sides of the tip.

11. The annular sawing structure as claimed in claim 8, wherein the cutting insertion and the reduced end are formed in a step shape.

12. The annular sawing structure as claimed in claim 8, wherein the cutting insertion and the reduced end are formed in a step shape and a reduced cone shape respectively.

13. The annular sawing structure as claimed in claim 8, wherein between the positioning drill and the connecting member is defined a fixing structure to position the positioning drill.

14. The annular sawing structure as claimed in claim 13, wherein the fixing structure includes a screwed bore communicating with the groove and formed on an outer periphery of the connecting member to screw with a bolt, and includes a recess disposed on the positioning drill where is in response to the screwed bore of the connecting member.
